(19) United States
(12) Patent Application Publication
(10) Pub. No.: US 2017/0072850 A1
(43) Pub. Date: Mar. 16, 2017

(54) DYNAMIC VEHICLE NOTIFICATION SYSTEM AND METHOD

(71) Applicant: Pearl Automation Inc., Scotts Valley, CA (US)

(72) Inventors: Robert Curtis, Scotts Valley, CA (US); Saket Vora, Scotts Valley, CA (US); Brian Sander, Scotts Valley, CA (US); Joseph Fisher, Scotts Valley, CA (US); Bryson Gardner, Scotts Valley, CA (US); Tyler Mincey, Scotts Valley, CA (US); Ryan Du Bois, Scotts Valley, CA (US); Jorge Fino, Scotts Valley, CA (US); Aman Sikka, Scotts Valley, CA (US)

(21) Appl. No.: 15/265,246

(22) Filed: Sep. 14, 2016

Related U.S. Application Data
(60) Provisional application No. 62/218,212, filed on Sep. 14, 2015.
(60) Provisional application No. 62/351,853, filed on Jun. 17, 2016.

(51) Int. Cl. B60Q 9/00

(52) U.S. Cl. CPC B60Q 9/00

(57) ABSTRACT

A method for dynamic notification generation for a driver of a vehicle, including receiving a first data set indicative of vehicle operation, predicting an imminent driving event based on the first data set, determining a notification associated with the imminent driving event, controlling a vehicle notification system to provide the notification, receiving a second data set indicative of vehicle operation, determining a notification effect of the notification on a behavior of a driver of the vehicle, and generating a user profile based on the notification effect.

### CROSS-REFERENCE TO RELATED APPLICATIONS

This application claims the benefit of U.S. Provisional Application No. 62/218,212 filed 14 Sep. 2015 and U.S. Provisional Application No. 62/351,853 filed 17 Jun. 2016, which are incorporated in their entireties by this reference. This application incorporates U.S. application Ser. No. 15/146,705, filed 4 May 2016, herein in its entirety by this reference.

### TECHNICAL FIELD

This invention relates generally to the vehicle field, and more specifically to a new and useful automatic vehicle warning system and method in the vehicle field.

### BRIEF DESCRIPTION OF THE FIGURES

FIG. 1 is a flowchart diagram of the method of contextual user notification generation.

FIG. 2 is a perspective view of a variation of the sensor module mounted to a vehicle.

FIG. 3 is a perspective view of a variation of the hub.

FIG. 4 is a schematic representation of a variation of the system, including on-board vehicle systems and remote systems.

FIG. 5 is schematic representation of a first variation of the method.

FIG. 6 is a schematic representation of a second variation of the method.

FIG. 7 is an example of different notification parameter selection for different drivers, given substantially the same vehicle operation data.

FIG. 8 is a second example of user notification display, including a “slow” notification in response to determination of an imminent object crossing an anticipated vehicle path.

FIG. 9 is a third example of user notification display, including a parking assistant, in response to determination of a parking event.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

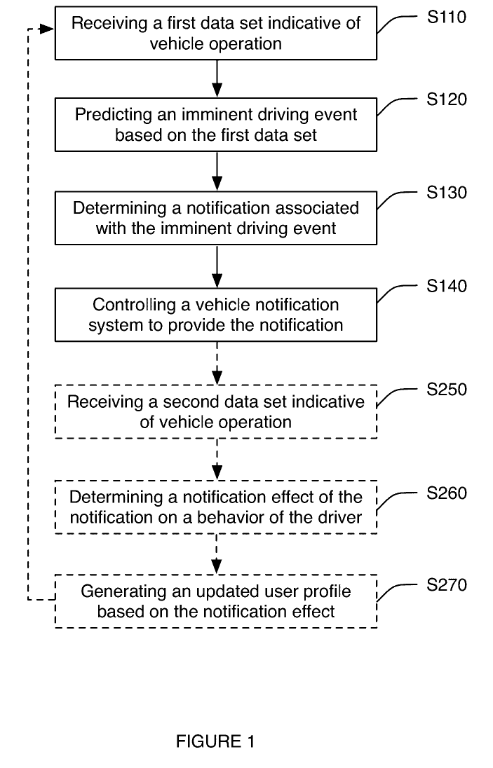

As shown in FIG. 1, the method of dynamic vehicle notification generation includes providing a notification S100 and determining user profile updates S200. Providing a notification S100 can include: receiving a first data set indicative of vehicle operation S110; predicting an imminent driving event based on the first data set S120; determining a notification associated with the imminent driving event S130; and controlling a vehicle notification system to provide the notification at a notification time S140. Determining user profile updates S200 can include: receiving a second data set indicative of vehicle operation S250; determining a notification effect of the notification on a behavior of the driver S260, based on the second data set; and generating a user profile based on the notification effect S270. The method functions to notify (e.g., warn) a driver or passenger of driving events, such as possible or future vehicle collisions, obstacle collisions, bad drivers, traffic, vehicle maintenance, or near misses. The method can additionally automatically generate, send, and/or execute vehicle notification system control instructions, vehicle control instructions, or any other suitable set of control instructions. The method can additionally automatically generate and send requests to third parties. For example, the method can automatically generate and send a maintenance request to an auto shop in response to the occurrence of a collision or detection of a vehicle fault. The method can optionally be repeated for each driving session, for each repeated driving event, or repeated at any suitable frequency.

The inventors have discovered that providing contextual warnings to drivers can reduce the occurrence of adverse driving events, such as vehicle collisions. Conventional vehicles do not have the ability to provide these contextual warnings, as they lack the requisite: sensors, connection to external data sources and dynamic updates (e.g., due to lack of a cellular connection), access to a large population of drivers, and/or access to driver-specific habits and preferences. In contrast, this system and method provide such sensors, data connections, and/or data sources, which are leveraged to generate near-real time notifications for the driver.

### 2. System.

This method is preferably performed using a set of on-board vehicle systems, including a sensor module, a hub (e.g., sensor communication and/or data processing hub), a vehicle notification system, and/or built-in vehicle monitoring systems (e.g., odometers, wheel encoders, BMS, on-board computer, etc.), but can additionally or alternatively be used with a remote computing system (e.g., remote server system). An example is shown in FIG. 4. The sensor module, hub, and any other suitable on-board vehicle systems can form a vehicle sensor system, preferably attached to the vehicle. However, the method can be performed with any other set of computing systems.

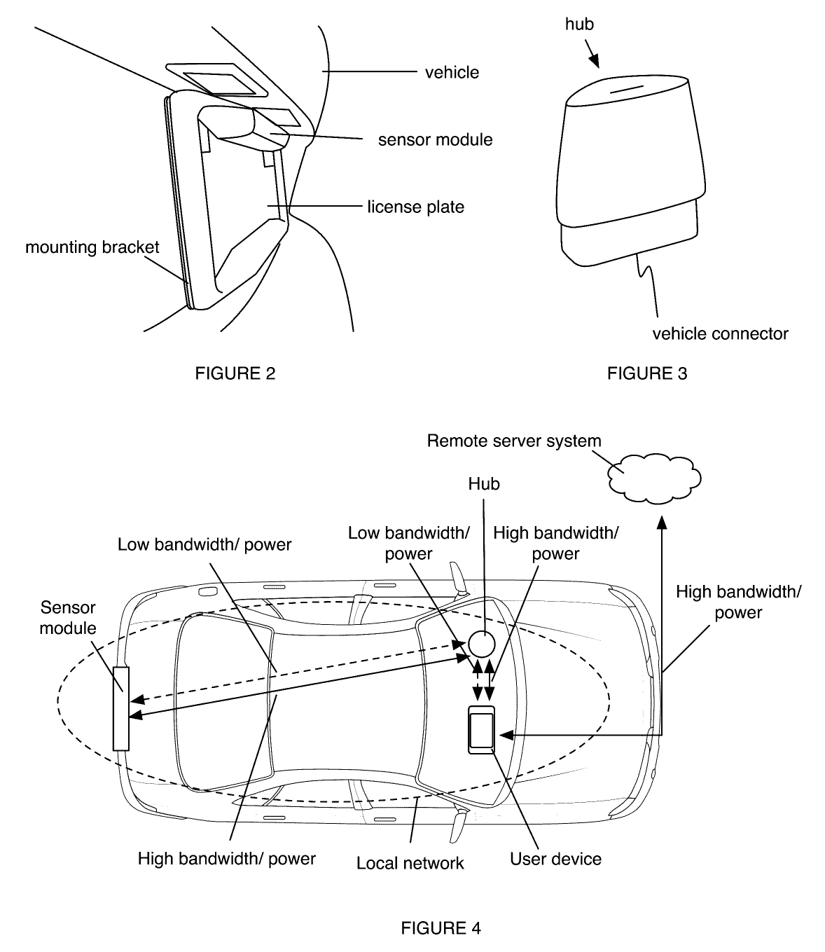

The sensor module of the system functions to record sensor measurements indicative of the vehicle environment and/or vehicle operation. As shown in FIG. 2, the sensor module is configured to mount to the vehicle (e.g., vehicle exterior, vehicle interior), but can alternatively be otherwise arranged relative to the vehicle. In one example, the sensor module (e.g., a camera frame) can record images, video, and/or audio of a portion of the vehicle environment (e.g., behind the vehicle, in front of the vehicle, etc.). In a second example, the sensor module can record proximity measurements of a portion of the vehicle (e.g., blind spot detection, using RF systems). The sensor module can include a set of sensors (e.g., one or more sensors), a processing module, and a communication module. However, the sensor module can include any other suitable component. The sensor module is preferably operable between a standby and streaming mode, but can alternatively be operable in any other suitable mode.

The set of sensors function to record measurements indicative of the vehicle environment. Examples of sensors that can be included in the set of sensors include: cameras (e.g., stereoscopic cameras, multispectral cameras, hyperspectral cameras, etc.) with one or more lenses (e.g., fisheye lens, wide angle lens, etc.), temperature sensors, pressure sensors, proximity sensors (e.g., RF transceivers, radar transceivers, ultrasonic transceivers, etc.), light sensors, audio sensors (e.g., microphones) or any other suitable set of sensors. The sensor module can additionally include a signal emitter that functions to emit signals measured by the sensors (e.g., when an external signal source is insufficient). Examples of signal emitters include light emitters (e.g., lighting elements), such as white lights, IR lights, RF, radar, or ultrasound emitters, audio emitters (e.g., speakers), or include any other suitable set of emitters.

The processing module of the sensor module functions to process the sensor measurements, and control sensor module operation (e.g., control sensor module operation state, power consumption, etc.). The processing module can be a microprocessor, CPU, GPU, or any other suitable processing unit.

The communication module functions to communicate information, such as the raw and/or processed sensor measurements, to an endpoint. The communication module can be a single radio system, multiradio system, or support any suitable number of protocols. The communication module can be a transceiver, transmitter, receiver, or be any other suitable communication module. Examples of communication module protocols include short-range communication protocols, such as BLE, Bluetooth, NFC, ANT+, UWB, IR, and RF, long-range communication protocols, such as WiFi, Zigbee, Z-wave, and cellular, or support any other suitable communication protocol. In one variation, the sensor module can support one or more low-power protocols (e.g., BLE and Bluetooth), and support a single high- to mid-power protocol (e.g., WiFi). However, the sensor module can support any suitable number of protocols.

In one variation, the sensor module can additionally include an on-board power source (e.g., battery), and function independently from the vehicle. This variation can be particularly conducive to aftermarket applications (e.g., vehicle retrofitting), in which the sensor module can be mounted to the vehicle (e.g., removably or substantially permanently), but not rely on vehicle power or data channels for operation. In one example of this variation, the sensor module can additionally include an energy harvesting module (e.g., solar cell) configured to recharge the on-board power source and/or power the sensor module. However, the sensor module can be wired to the vehicle, or be connected to the vehicle in any other suitable manner.

The hub (e.g., car adapter) of the system functions as a communication and processing hub for facilitating communication between the vehicle notification system and sensor module. The hub (example shown in FIG. 3) can include a vehicle connector, a processing module and a communication module, but can alternatively or additionally include any other suitable component.

The vehicle connector of the hub functions to electrically (e.g., physically) connect to a monitoring port of the vehicle, such as to the OBDII port or other monitoring port. Alternatively, the hub can be a stand-alone system or be otherwise configured. More specifically, the vehicle connector can receive power from the vehicle and/or receive vehicle operation data from the vehicle. The vehicle connector is preferably a wired connector (e.g., physical connector, such as an OBD or OBDII diagnostic connector), but can alternatively be a wireless communication module. The vehicle connector is preferably a data and power connector, but can alternatively be data-only, power-only, or have any other configuration. When the hub is connected to a vehicle monitoring port, the hub can receive both vehicle operation data and power from the vehicle. Alternatively, the hub can only receive vehicle operation data from the vehicle (e.g., wherein the hub can include an on-board power source) or only receive power from the vehicle. Additionally or alternatively, the hub can transmit data to the vehicle (e.g., operation instructions, etc.) and/or perform any other suitable function.

The processing module of the hub functions to manage communication between the system components. The processing module can additionally function to detect an imminent driving event and/or generate a notification in response to imminent driving event determination. The processing module can additionally function as a processing hub that performs all or most of the resource-intensive processing in the method. For example, the processing module can: route sensor measurements from the sensor module to the vehicle notification system, process the sensor measurements to extract data of interest, generate user interface elements (e.g., warning graphics, notifications, etc.), control user interface display on the vehicle notification system, or perform any other suitable functionality. The processing module can additionally generate control instructions for the sensor module and/or vehicle notification system (e.g., based on user inputs received at the vehicle notification system, vehicle operation data, sensor measurements, external data received from a remote system directly or through the vehicle notification system, etc.), and send or control the respective system according to control instructions. Examples of control instructions include power state instructions, operation mode instructions, vehicle operation instructions, or any other suitable set of instructions. The processing module can be a microprocessor, CPU, GPU, or any other suitable processing unit. The processing module can optionally include memory (e.g., flash, RAM, etc.) or any other suitable computing component. The processing module is preferably powered from the vehicle connector, but can alternatively or additionally be powered by an on-board power system (e.g., battery) or be otherwise powered. The hub can optionally include outputs, such as speakers, lights, data outputs, haptic outputs, thermal outputs, or any other suitable output. The outputs can be controlled as part of the vehicle notification system or otherwise controlled.

The communication system of the hub functions to communicate with the sensor module and/or vehicle notification system. The communication system can additionally or alternatively communicate with a remote processing module (e.g., remote server system). The communication system can additionally function as a router or hotspot for one or more protocols, and generate one or more local networks. The communication module can be a single radio system, multiradio system, or support any suitable number of protocols. The communication module can be a transceiver, transmitter, receiver, or be any other suitable communication module. Examples of communication module protocols include short-range communication protocols, such as BLE, Bluetooth, NFC, ANT+, UWB, IR, and RF, long-range communication protocols, such as WiFi, Zigbee, Z-wave, and cellular, or support any other suitable communication protocol. One or more communication protocols can be shared between the sensor module and the hub. Alternatively, the hub can include any suitable set of communication protocols.

The vehicle notification system of the system functions to provide notifications associated with the processed sensor measurements to the user. The vehicle notification system can additionally function as a user input to the system, function as a user identifier, function as a user proximity indicator, function as a remote computing system communication channel, or perform any other suitable functionality. The vehicle notification system preferably runs an application (e.g., web-based application or native application), wherein the application associates the vehicle notification system with a user account (e.g., through a login) and connects the vehicle notification system to the hub and/or sensor module, but can alternatively connect to the hub and/or sensor module in any other suitable manner. The vehicle notification system can include: a display or other user output, a user input (e.g., a touchscreen, microphone, or camera), a processing module (e.g., CPU, microprocessor, etc.), a wired communication system, a wireless communication system (e.g., WiFi, BLE, Bluetooth, etc.), or any other suitable component. The vehicle notification system preferably includes a user device, but can additionally or alternatively include a vehicle navigation and/or media system, a vehicle speaker system, the hub, and/or any other suitable notification device. The user device preferably has a display and a speaker, and is preferably arranged or arrangeable within the vehicle. Examples of user devices include smartphones, tablets, laptops, smartwatches (e.g., wearables), or any other suitable user device. The system can be used with one or more vehicle notification systems, during the same or different driving session. The multiple vehicle notification systems can be associated with the same user account, different user accounts (e.g., different users, different drivers, etc.), or any other suitable user.

### 3. Benefits.

This method can confer several benefits over conventional notification systems. First, in some variants, the vehicle data analysis can be split (e.g., performed by different systems) between a remote computing system and on-board vehicle systems. In one example, the on-board vehicle systems can identify events that require only vehicle data (e.g., sensor module data, vehicle operation data, etc.; such as a reverse event), while the remote computing system can identify events that require both external data and vehicle data (e.g., nearby driver profile data and vehicle data; such as a bad driver warning) and/or update the analysis algorithms. This can function to reduce the processing load and/or communication load on power-restricted systems (e.g., the on-board vehicle systems). This can additionally enable the algorithms to be refined based on multiple vehicles' data, instead of refining the algorithms based on a single set of data. This can also enable near-real time notification generation and display (e.g., without waiting for lag due to remote connections) for urgent notifications. Splitting the processing can additionally enable concurrent access to more data sources while minimizing the bandwidth used by on-board vehicle systems. This can be particularly desirable when connections with limited bandwidth are used to communicate between on-vehicle systems and remote systems.

Second, by using data from the sensor module, the method leverages the additional context provided by the additional sensors of the sensor module to make the driving event determination. This can enable more refined notifications, fewer false positives, fewer false negatives, or otherwise increase the accuracy and/or relevance of the notifications to the user.

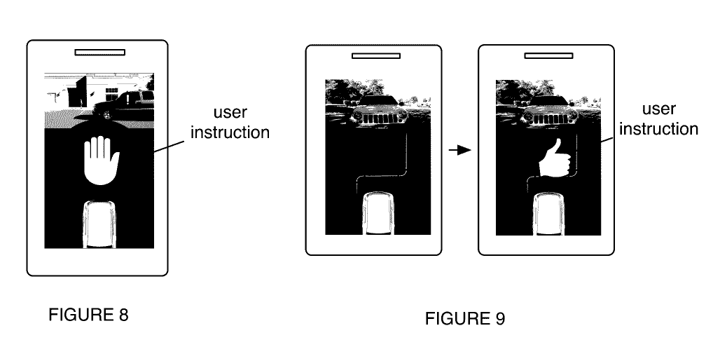

Third, by using a user profile to determine imminent driving events and/or to generate notifications, the method can tailor the notifications to a user's specific preferences or driving style. In a first example, a notification can be served later (e.g., closer to the occurrence of the driving event) to a first user with faster response times, and served earlier to a second user with slow response times. In a second example, a haptic notification can be selected for a user that prefers haptic notifications, and a visual notification can be selected for a user that prefers visual notifications. In a third example, in wet conditions, a “slow” notification or instruction (example shown in FIG. 8) can be sent to a first vehicle notification system associated with a vehicle with rear wheel drive, while the notification is not sent to a second vehicle notification system associated with a vehicle with all-wheel or front-wheel drive. In a fourth example, a first notification type can be used to notify a user when the associated user profile indicates that the user did not respond to a second notification type in the past. However, the user profile can be used in any other suitable manner.

Fourth, by determining user feedback and refining the algorithms based on the user feedback, the method confers the benefit of more accurately detecting imminent driving events and generating more compelling notifications. The method can additionally confer the benefit of personalizing the algorithms for each driver (e.g., based on the user feedback for that individual), each vehicle, or across a population of drivers or vehicles. However, the method can confer any other suitable benefit.

### 4. Variations.

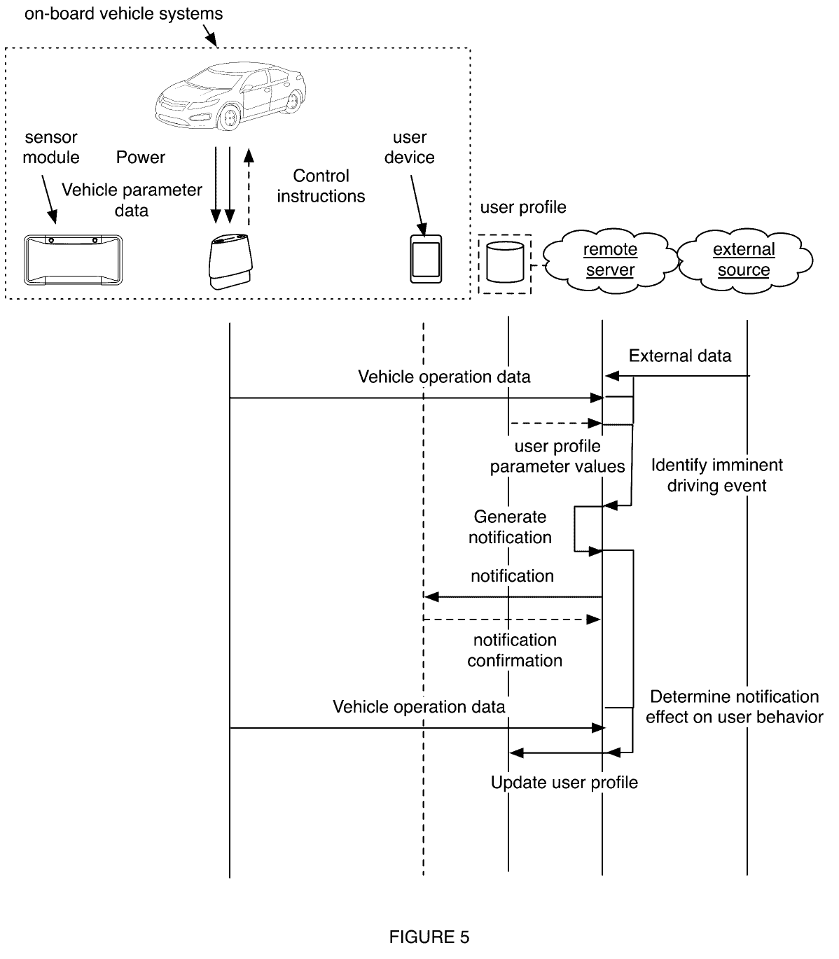

As shown in FIG. 5, in a first variation of the method, the notification is generated by a remote computing system (e.g., a set of servers). In this variation, the vehicle data (e.g., data indicative of vehicle operation, vehicle-originated data set, etc.) is sent from an on-board vehicle system (e.g., user device, alternatively a hub) to the server, wherein the server analyzes the vehicle data for indicators of driving events and generates the notification based on the vehicle data when a driving event is determined (e.g., predicted, detected, etc.). The notification can additionally be generated based on external data received (e.g., retrieved or passively received) by the server. The notification is then sent to the vehicle system, wherein a vehicle notification system (e.g., user device, vehicle display, vibrating seat, vibrating steering wheel, vehicle speakers, vehicle brake system, etc.) provides the notification. The remote computing system can assume that the notification is provided within a predetermined time period of notification transmission, or can additionally receive confirmation of notification display at a notification time from an on-board vehicle system. Secondary vehicle data can be recorded after the notification time, which can be used to detect subsequent driving events. The secondary vehicle data can additionally be sent to the remote computing system, wherein the remote computing system determines the efficacy of the notification in changing driver behavior, and updates the driving event indicator determination processes based on the secondary vehicle data.

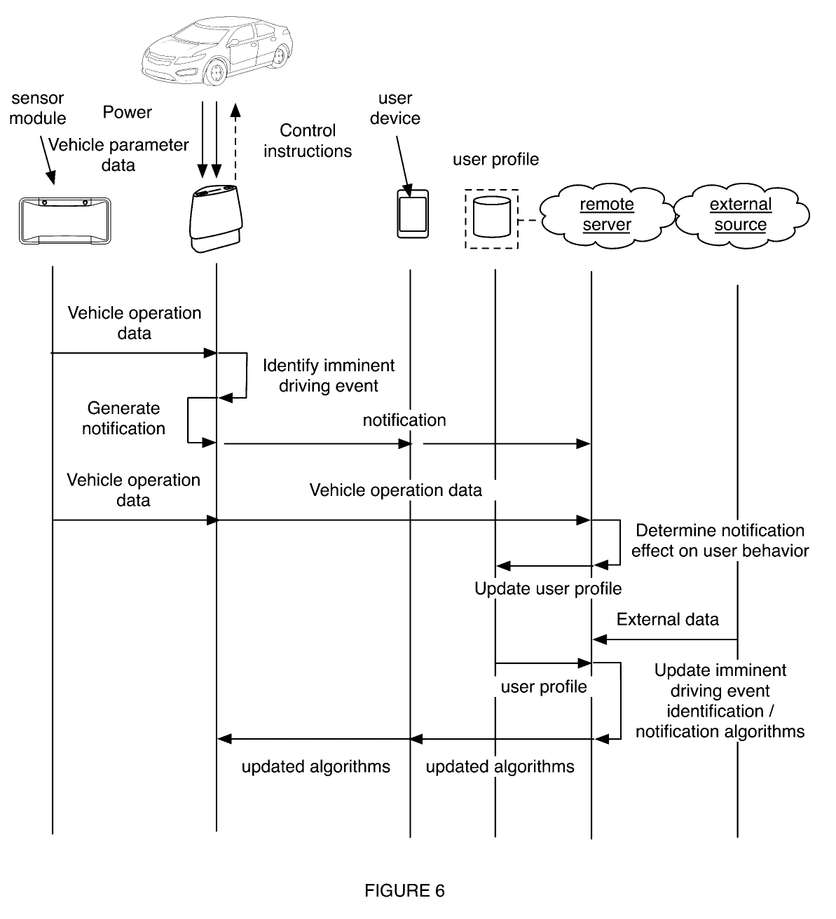

As shown in FIG. 6, in a second variation of the method, the notification is generated on-board the vehicle by an on-board vehicle system. The notification is preferably generated by a hub, but can alternatively be generated by a user device, vehicle notification system, sensor module, or vehicle computing system (e.g., vehicle processor). In this variation, the vehicle data analysis (e.g., driving event indicator determination) and notification generation processes (e.g., algorithms, user profiles, vehicle profiles, etc.) are preferably stored by the on-board vehicle system, such that all processing occurs on-board the vehicle. These algorithms can be periodically updated with new algorithms, wherein the new algorithms can be received through a wireless connection to a remote computing system (e.g., a remote server system), be dynamically retrieved from the remote computing system, or be otherwise received. In this variation, the vehicle data is collected by the set of on-board vehicle systems (e.g., sensor modules, hub, user device), and sent to an on-board vehicle system of the set (the processing system). The processing system retrieves the vehicle data analysis algorithms (e.g., from the remote computing system, processing system storage, storage of another on-board vehicle system, etc.), and analyses the vehicle data using the retrieved algorithms. The vehicle data can additionally be analyzed in light of external data, which can be received from a remote computing system. The external data can be received in near-real time, be asynchronous data (e.g., old data, historic vehicle data, historic user data, historic population data, etc.), or be data for any suitable time relative to the analysis time. The processing system then generates notifications (if warranted), and facilitates notification presentation to the user through the vehicle notification system at a notification time. Secondary vehicle data can additionally be recorded by the on-board vehicle system after the notification time, which can be used to detect subsequent driving events. In a first specific variation, the on-board vehicle system can additionally store and/or execute learning algorithms that process the secondary vehicle data to determine the efficacy of the notification in changing driver behavior, and can additionally update the vehicle data analysis algorithms stored on-board. In a second specific variation, the notification parameters (e.g., notification time, type of notification, vehicle data parameter combination triggering the notification, etc.) can be sent to a remote computing system along with the secondary vehicle parameters. In the second specific variation, the remote computing system analyzes the effect of the notification on driver behavior and generates the updated vehicle data analyses algorithms, which can be subsequently sent to the processing system. In the second specific variation, the notification parameters and secondary vehicle data can be sent in near-real time (e.g., as the notification is generated or displayed, as the secondary vehicle data is recorded), asynchronously (e.g., far after the secondary vehicle data is collected), or at any other suitable time. In the second specific variation, the algorithms can be updated in near-real time (e.g., as the new algorithms are generated), asynchronously (e.g., after the driving session; when the processing system connects to a specific data connection, such as a WiFi connection; etc.), or at any other suitable time. The algorithms can be updated directly (e.g., directly sent to the processing system), indirectly (e.g., downloaded to the user device at a first time, wherein the user device provides the algorithms to the processing system when the user device is subsequently connected to the processing system, etc.), or in any other suitable manner.

In a third variation of the method, some classes of notifications can be generated on-board, while other notification classes can be generated remotely. For example, notifications for imminent collisions can be generated based on near-real time vehicle data (e.g., as in the second variation above), while notifications for bad drivers and traffic conditions can be generated remotely (e.g., as in the first variation above). Similarly, some algorithms can be updated on-board, while other algorithms are updated remotely. For example, user identification algorithms can be updated on-board, while notification algorithms (to result in a desired user response) can be updated remotely. However, the notifications can be generated in any other suitable manner, using any suitable system.

### 5. Method.

### 5.1 Providing a Notification.

Receiving a first data set indicative of vehicle operation Silo functions to receive data indicative of the vehicle environment and/or the vehicle itself. The data set can subsequently and/or concurrently be used to identify an imminent driving event. The data set can be received by the vehicle notification system, the hub, the remote computing system (e.g., received from the hub, vehicle notification system, or other on-board vehicle system having a long-range communication module through the long-range communication channel). The data set is preferably received in real or near-real time (e.g., streamed), but can alternatively be received periodically or at any suitable frequency.

The data set is preferably generated and/or collected by the on-board vehicle systems (e.g., by the sensors of the on-board vehicle systems, such as the sensors of the sensor system, vehicle, and/or user device), but additionally or alternatively can be generated by external sensors (e.g., sensors of systems on other vehicles, sensors in or near roadways, airborne sensors, satellite sensors, etc.), or by any other suitable systems. The data set can include system data (e.g., images, accelerometer data, etc. sampled by the system), vehicle-originated data (e.g., vehicle operation data), external data (e.g., social networking data, weather data, etc.), or any other suitable data. The data set can be collected at a first collection time, during a first collection time window (extending a predetermined time period prior to and/or after a reference time), or at any other suitable time. In one example, the data set can be continually or periodically collected and analyzed, wherein the collection time for data underlying a detected driving event can be considered as the first collection time. In another example, the data set can be collected as a prespecified collection time. The reference time can be the occurrence time of a trigger event (e.g., user device connection to the processing system, vehicle ignition start, etc.), a predetermined time (e.g., 3p on Tuesday), or be any other suitable reference time.

Vehicle operation data can include vehicle environment data, vehicle operation parameters, or any other suitable data indicative of general vehicle operation. Vehicle operation parameters include vehicle state, vehicle acceleration, vehicle velocity, vehicle pitch, vehicle roll, transmission position (e.g., gear), engine temperature, compression rate, fuel injection rate, battery state of charge, driver input status (e.g., steering wheel angle, throttle position, brake pedal position, etc.), or any other suitable parameter indicative of operation of the vehicle itself. Vehicle environment data can include: hub and/or sensor module state, hub and/or sensor module sensor data, vehicle sensor data (e.g., external vehicle sensors), mobile device state, or any other suitable data indicative of the driving environment surrounding the vehicle. Examples of vehicle environment data include: hub and/or sensor module state of charge, hub and/or sensor module lifecycle, timers, video, audio, temperature measurements, pressure measurements, object proximity measurements, ambient light measurements (e.g., solar measurements, solar cell power provision, etc.), location data (e.g., geolocation, geofencing data, etc.), inertial sensor measurements, occupancy measurements, biometric metrics, or any other suitable measurement. Vehicle environment data can additionally include identifiers for the drivers or vehicles surrounding the vehicle (surrounding driver identifiers). Surrounding driver identifiers can include video or images of the surrounding vehicle's license plate, audio of the engine note, user device identifiers received through a communication channel (e.g., through iBeacon or another BTLE protocol), the instant vehicle's location (e.g., wherein the surrounding drivers are identified based on their location data, sent to the remote system), or include any suitable data.

In one variation, the data set includes an image data set collected by one or more cameras of a sensor module. The data set, including the image data set (e.g., the entire data set, a portion of the data set), can be wirelessly transmitted by the sensor module to the hub in near-real time (e.g. substantially concurrently with data sampling or collection). In a specific example of this variation, the images of the data set are cropped, dewarped, sampled, and/or otherwise altered by the sensor module before transmission to the hub. In a second variation, the data set includes a vehicle-originated data set (e.g., generated by the vehicle, collected by sensors of the vehicle). In a specific example of this variation, the vehicle-originated data set includes data indicative of the vehicle being in a reverse gear and the vehicle engine being on, and is received by the hub through an OBD-II diagnostic connector. In a second example, the data set includes both an image data set and the vehicle-originated data set. In a third example, the data set includes only the vehicle-originated data set. The method can additionally include receiving a vehicle-originated data set not included in the first data set.

The method can include wirelessly transmitting the first data set (e.g., from the sensor module to the hub, to a user device, to a remote computing system, etc.) before predicting an imminent driving event S120, or additionally or alternatively can include transmitting any suitable data in any suitable transmission manner. The first data set can be transmitted by the on-board wireless communication module(s), but can be otherwise transmitted.

Predicting an imminent driving event based on the data set S120 functions to determine whether a notification-worthy event is about to occur. Imminent driving events (e.g., notification-worthy events) can include: adverse events (e.g., a vehicle collision, theft), vehicle performance events (e.g., oversteer, understeer, etc.), traffic events (e.g., upcoming traffic), parking events, reversing events, bumps (e.g., accelerometer measurements over a threshold value after a period of stasis), vehicle operation events, vehicle reversal events (e.g., backward relative to a forward direction, along a vector opposing a forward vector extending from the driver seat to the steering wheel, relative to a forward direction associated with typical vehicle driving, etc.), or any other suitable event that can influence a user's driving experience. The imminent driving event can be identified by the system receiving the vehicle operation data, but can alternatively or additionally be identified by the vehicle notification system, sensor module, hub, remote computing system, or any other suitable processing system. The method can additionally include predicting that the imminent driving event will occur at a predicted event time.

Each imminent driving event (or class of events) is preferably associated with a set of measurement parameter values, a pattern of measurement parameter values, or other set of defining characteristics. Alternatively, the probability of a given imminent driving event occurring can be calculated from the first data set, wherein the notification can be sent in response to the probability exceeding a threshold, and/or the imminent driving event can be otherwise characterized. The defining characteristic set, probability calculation method, and/or other characterization method is preferably generated by applying machine learning techniques, but can alternatively be specified by a user or be otherwise determined. Machine learning techniques that can be applied include supervised learning, clustering, dimensionality reduction, structured prediction, anomaly detection, and neural nets, but can alternatively include any other suitable technique. Examples of supervised learning techniques include decision trees, ensembles (bagging, boosting, random forest), k-NN, Linear regression, naive Bayes, neural networks, logistic regression, perceptron, support vector machine (SVM), and relevance vector machine (RVM). Examples of clustering include BIRCH, hierarchical, k-means, expectation-maximization (EM), DBSCAN, OPTICS, and mean-shift. Examples of dimensionality reduction include factor analysis, CCA, ICA, LDA, NMF, PCA, and t-SNE. An example of structured prediction includes graphical models (Bayes net, CRF, HMM). An example of anomaly detection includes k-NN Local outlier factor. Examples of neural nets include autoencoder, deep learning, multilayer perceptron, RNN, Restricted Boltzmann machine, SOM, and convolutional neural network. However, any other suitable machine learning technique can be used. The machine learning techniques and/or models can be substantially static or dynamically change over time (e.g., based on user feedback and/or response).

In one variation, an imminent driving event is predicted when a threshold number or percentage of characteristics is met. In a second variation, an imminent driving event is predicted when a score calculated based on the data set and characteristic set exceeds a threshold score. In this variation, different parameters can be given different weights. In a third variation, the probability of a given imminent driving event is calculated from the data set (e.g., based on a full feature set or reduced feature set), wherein the imminent driving event is subsequently predicted when the probability exceeds a threshold probability. In one example, an imminent driving event can be predicted when power is received at the hub. In a second example, imminent driving event can be predicted when the sensor patterns (e.g., hub, vehicle sensor system, and/or user device accelerometer patterns) substantially match a pre-classified pattern. In a third example, an imminent driving event can be predicted based on a vehicle-originated data set (e.g., vehicle-originated data included in or separate from the first data set), such as data read from a vehicle data bus (e.g., CAN bus, ISO 9141-2, SAE J1850, Ethernet, LIN, FlexRay, etc.; wirelessly, through a wired connection to the vehicle data bus such as an OBD or OBD-II diagnostic connector or a spliced connection, etc.). In a fourth variation, a given imminent driving event is predicted when a preceding event, associated with the imminent driving event, is detected. For example, the preceding event can be a transmission transition to and/or operation in the reverse gear, wherein the preceding event is associated (e.g., statistically, by a user, etc.) with an imminent reversal event. However, the imminent driving event can be otherwise predicted.

In one embodiment, in which the first data set includes an image, an imminent driving event associated with the image can be predicted (e.g., based on the image, additionally or alternatively based on other data). In variations that include analyzing the image (and/or a video including the image), the image can be adjusted to compensate for system tilt. For example, the sensor module can include an accelerometer, and the image can be adjusted to compensate for system tilt relative to a gravity vector, determined based on data sampled by the accelerometer (e.g., in response to sensor module attachment to the vehicle, at regular intervals, concurrent with image capture, at any other suitable time, etc.), before analyzing the image (e.g., to predict an imminent driving event, to determine which image manipulation methods should be applied, etc.).

In one example of this embodiment, the method can additionally include predicting a region of the image for use in the notification or analysis (e.g., the entire image, smaller than the entire image) associated with the imminent driving event (e.g., a region depicting an obstacle, a pothole, a traffic light, etc.). In a specific example, the sensor module accelerometer measurement sampled (e.g., upon sensor module attachment to the vehicle) can be used to automatically correct for the image horizon (e.g., automatically identify regions of the image to crop or warp; automatically identify pixels of the image to warp or re-map; etc.). This can function to correct for differences in mounting surface angles across different vehicle types. The sensor module accelerometer measurement can be periodically re-sampled (e.g., to correct for ground tilt during sensor module installation); corrected with a substantially concurrent hub accelerometer measurement (e.g., recorded within a time period of sensor module accelerometer measurement); or otherwise adjusted. The accelerometer measurements can optionally be used to determine whether the sensor module is properly seated within a mounting system (e.g., by comparing the instantaneous accelerometer measurement to an expected measurement), or be otherwise used.

In a second example, in which the image is an image of a portion of an obstacle (e.g., include a region depicting part or all of the obstacle), predicting the imminent driving event S120 can include: determining an obstacle position of the obstacle relative to the vehicle and/or predicting a vehicle path of the vehicle (e.g., based on image and/or video analysis; based on proximity sensor data, steering angle data, other data of the first data set, other data collected by the on-board vehicle systems; based on external data such as historical data, user profiles, and/or vehicle profiles; etc.); and determining a potential collision between the vehicle and the obstacle based on the obstacle position and the vehicle path (e.g., when the predicted vehicle path overlaps with or comes within a threshold distance of the obstacle position). A variant of the second example, in which the obstacle is a moving obstacle (e.g., pedestrian, cyclist, vehicle, etc.), can additionally or alternatively include predicting an obstacle path of the obstacle (e.g., using a similar or dissimilar technique as predicting the vehicle path) and determining a potential collision between the vehicle and the obstacle based on the obstacle path and the vehicle position and/or path.

In some variants, the imminent driving event can additionally be predicted based on external data. External data is preferably data that is generated, received from, or stored external the systems on-board the vehicle (e.g., aside from the vehicle itself, the sensor module, the hub, and the vehicle notification system), but can alternatively or additionally be data generated based on data received from the on-board vehicle systems (e.g., user profile data), or be any other suitable set of data. Examples of external data sources include: social networking system data (e.g., Facebook, Linkedin, Twitter, etc.; using multiple users' information, information of a user account associated with the driver, etc.), news streams, weather sources, terrain maps, road classification dataset (e.g., classifying the location as a freeway, surface street, parking lot, etc.), geographic location profiles (e.g., real-time traffic, historic occurrence probability of a given class or specific driving event, driving law differences between different geographic locations, recent changes to local driving law, etc.), user profile data (e.g., of the vehicle's driver; of the vehicle; of surrounding drivers, pedestrians, or any other suitable users; etc.), or any other suitable external data. Surrounding users can be users within a threshold distance, such as a geographic (e.g., 5 m, 1 km, etc.), driving (e.g., 1.5 blocks, 200 m along roadways, etc.), or temporal (e.g., 3 s, 1 min, etc.) distance.

In some variants, the method can include classifying the imminent driving event as belonging to a driving event class. A driving event class can be associated with a driving task (e.g., parallel parking, looking for a parking spot, reversing, changing lane, turning, driving above or below a threshold speed such as 10 mph), a driving setting (e.g., freeway, residential, off-road, parking lot, etc.), a collision type (e.g., with a stationary object, with a vehicle, rear collision, side collision, etc.), or can be any other suitable class. The imminent driving event can be classified based on the first data set, a vehicle-originated data set, and/or any other suitable data. The imminent driving event can be classified by a classification module (e.g., neural network trained on a supervised training set, etc.), a regression module, pattern matching module, or classified in any other suitable manner.

Determining a notification associated with the imminent driving event S130 functions to generate a notification suitable for the driver and the event. The notification can be determined based on the imminent driving event, the event class, the first data set, a vehicle-originated data set, a driving event class, and/or a user profile of the driver, and additionally or alternatively can be based on any other suitable data indicative of vehicle operation, other user profiles, vehicle profiles, historical data, and/or any other suitable information.

The notification can include notification components of any suitable type, including visual, auditory, and/or haptic. The notification can be associated with data processing techniques, such as image portion selection, image analyses, object analysis, object tracking, sensor syntheses, or other processing methods, wherein notification parameters (e.g., signal type, intensity, etc.) can be based on the results of said processing methods. For example, a first notification can be associated with object and depth analyses (e.g., performing an object depth analysis based on a stereoimage captured by the sensor module), while a second notification can be associated with image cropping only. The notification can be associated with notification templates, overlay types, image portions, output endpoints, or any other suitable set of parameters.

In one embodiment, the notification includes a visual component that includes displaying an image to a driver of a vehicle, wherein the image includes image data captured by a camera of a sensor module attached to the vehicle (e.g., near real-time display of video captured by the camera, delayed display of a still image captured by the camera, etc.).

Generating the image from the image data can include adjusting the image to compensate for camera tilt (e.g., based on camera orientation data, based on image analysis, etc.). For example, the sensor module can include an accelerometer, and the image can be adjusted to compensate for camera tilt relative to a gravity vector determined based on data sampled by the accelerometer (e.g., in response to sensor module attachment to the vehicle, at regular intervals, concurrent with image capture, etc.) before being displayed to the driver. Generating the image from the image data can include selecting portions of the image associated with the notification and/or imminent driving event. For example, when a parallel parking event is predicted, the curbside portion of the image can be selected for display. In a specific example, this can include selecting pixels within the curbside portion, de-warping the selected pixels, and re-mapping the selected pixels to a frame having predefined dimensions. This can be useful when the image frame is large relative to the display of the vehicle notification system (e.g., beyond a given ratio), is high-definition, and/or meets other image parameters. However, the image can be otherwise generated.

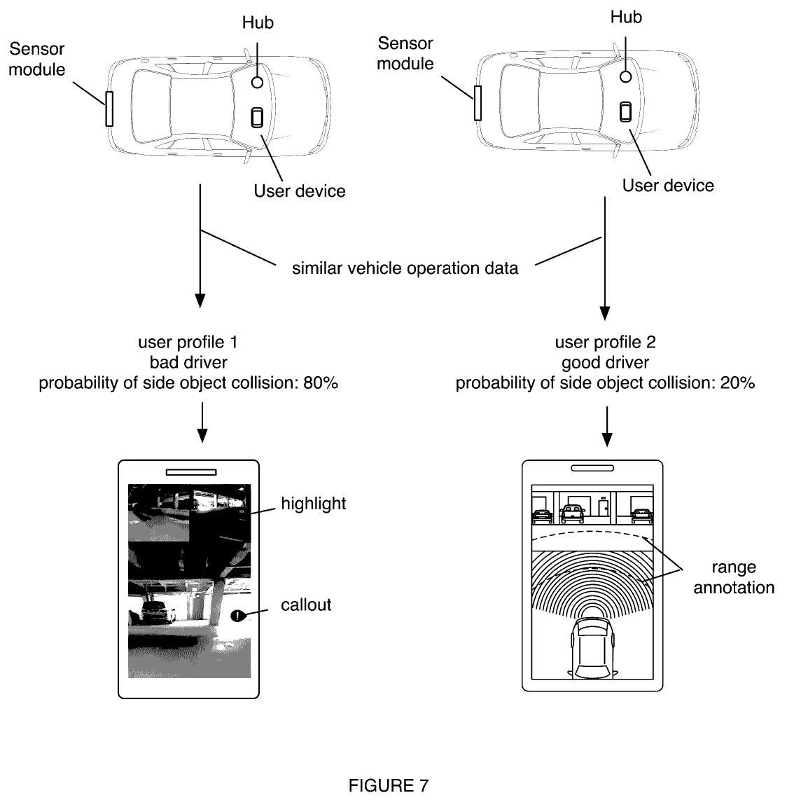

In a first variation of this embodiment, the generated image includes a portion of an obstacle and an overlay superimposed on the image after it was captured (specific examples shown in FIGS. 7-9). In a first example of this embodiment, the overlay includes a range annotation (e.g., a dashed line indicating an approximate distance from the vehicle). In a second example of this embodiment, the overlay can include a vehicle path (e.g., predicted path, ideal path, historical path, etc.). In a third example of this embodiment, the notification includes a concurrent display of multiple images, each image depicting a different region near the vehicle. In this example, the overlay can include a highlight of all or a portion of a first image, wherein the first image includes the obstacle, and a callout on a second image indicating the direction of the region depicted in the first image relative to the region depicted in the second image.

In a second variation of this embodiment, in which the method includes predicting a region of the image associated with the imminent driving event, the notification includes a notification image based on the region of the image. In this variation, generating the notification can include displaying a cropped version of the image, such that the region associated with the imminent driving event is easily discerned by the driver. In a first example of this variation, the notification image is the region of the image. In a second example of this variation, the notification image is a modified version of the image, in which a highlighting overlay is superimposed on the region of the image. In a third variation of this example, the notification includes concurrent display of multiple images (e.g., as described above, multiple image regions cropped from the same image, etc.). However, the notification can additionally or alternatively include any other suitable notification components.

In a second embodiment, the notification includes modifying operation of one or more vehicle controls (e.g., throttle, braking, steering, cruise control, etc.) of the vehicle. In a first variation of this embodiment, the notification includes reducing the vehicle speed and/or preparing the vehicle to reduce speed (e.g., to prevent or reduce the impact of a predicted imminent collision). A first example of this variation includes priming the vehicle brakes (e.g., such that driver depression of the brake pedal causes more rapid deceleration than a similar driver input would during normal operation). A second example of this variation includes remapping the accelerator pedal to reduce acceleration (e.g., reducing throttle amounts corresponding to all accelerator pedal positions, setting throttle amounts corresponding to the current accelerator pedal position and all lower acceleration positions to idle, etc.). A third example of this variation includes actuating the vehicle brakes to cause vehicle deceleration (e.g., light deceleration such as 0.2 g or 0.05-0.4 g, moderate deceleration such as 0.35-1 g, hard deceleration such as 0.9 g or greater). A fourth example of this variation includes actuating one or more vehicle foot pedals to gain the driver's attention (e.g., causing the brake pedal to vibrate). In a second variation of this embodiment, the notification includes controlling vehicle steering (e.g., to steer the vehicle away from an obstacle). However, the notification can include any suitable modification of vehicle control operation.

Determining the notification S130 can include selecting a notification class associated with a driving event class and determining the notification based on the notification class. One variation includes performing classification of the first data set and a vehicle-originated data set to predict the driving event class. In one example of this variation, the driving event class is a predicted collision with a moving vehicle, and the notification class associated with the driving event class is a user instruction (e.g., to brake). In this example, based on the notification class, a user instruction notification (e.g., as shown in FIG. 8) is determined.

Determining the notification S130 can include selecting notification parameters. The notification parameters can be learned, selected, or otherwise determined. The notification parameters for a given imminent driving event are preferably associated with and/or determined based on a user profile, but can be otherwise determined. In one variation, the notification parameters can be determined based on the user notification preferences, vehicle data, and external data. In a first example, video from a backup camera (example shown in FIG. 7) is selected for the notification when the vehicle data indicates that the vehicle is traveling at less than a threshold speed (e.g., 5 mph), the vehicle data provides a geographic location for the vehicle, and the road classification data classifies the geographic location as a parking lot. In a second example, a traffic map is selected as the notification when the vehicle data indicates that the vehicle is traveling at less than ₅ mph, the vehicle data provides a geographic location for the vehicle, and the road classification data classifies the geographic location as a freeway.

In a third example, the system can dynamically select and/or change the camera from which measurements are analyzed and/or the displayed view (e.g., switch between different cameras, alter camera orientations, select different regions of an image, zoom into or out of an image field, pan a zoomed-in view across an image field, etc.) based on the context. In a first specific example, the system can dynamically select the section of a video frame (image) associated with a curb (e.g., showing the curb, statistically associated with a curb, legally associated with the curb, such as the rightmost part of the frame, etc.) when the imminent driving event is a parallel parking event (e.g., determined based on geographic location, acceleration patterns, etc.), and select a wide view when the imminent driving event is a backup event in a parking lot (e.g., based on geographic location, acceleration patterns, etc.). In this first specific example, when the imminent driving event is a parallel parking event, the selected section of a video frame (e.g., the same frame, a subsequent frame, etc.) can be dynamically adjusted (e.g., based on vehicle movement relative to the curb). In a second specific example, in which the system includes a daylight camera (e.g., camera adapted to sample visible light) and a night vision camera (e.g., thermographic camera, camera adapted to sample both visible and infrared light, camera with an infrared illumination source, etc.), the system can dynamically select images from either or both cameras for analysis and/or display based on the time of day, geographic location, ambient light intensity, image signal quality, and/or any other suitable criteria (e.g., using the daylight camera during the day when available light is high, and using the night vision camera otherwise). In a third specific example, a user has previously selected a pan option (e.g., pan down, pan left, pan toward area indicated by user, pan toward detected object of interest, etc.) to provide an improved view of an object of interest (e.g., pothole, wall, rock, vehicle element such as a trailer hitch, etc.). In this third specific example, in response to detecting the object of interest, the view can automatically pan (e.g., in the same direction as the previous user selection, toward the detected object of interest, etc.). However, any other suitable action can be performed.

In a fourth example, the system can dynamically adjust the displayed views (e.g., add overlays, adjust contrast, adjust filters, etc.) based on the imminent driving event and/or detected context. In a specific example, the overlay color can be dynamically adjusted or selected to contrast with the colors detected in the portion of the overlaid image frame. However, the displayed frames can be otherwise adjusted. In a second variation, the notification parameters can be determined based on historic user notifications (e.g., all past notifications, past notifications for the specific imminent driving event, past notifications for the driving event class, etc.). In a first example, a different value for a notification parameter (e.g., notification type, such as haptic, visual, or auditory; notification sub-type, such as icon, highlight, or outline; notification intensity, such as volume, brightness, size, contrast, intensity, duration; etc.) is selected for each successive notification. This can prevent user acclimation to the notifications. In a second example, the user profile-specified value for a notification parameter is selected to indicate the same imminent driving event, wherein the user profile-specified value is learned from historic user responses to different types of notifications. However, the notification parameters can be otherwise determined.

The user profile functions to characterize a user's notification preferences, driving preferences, driving style, vehicle information, product experience history (e.g., sensor module and/or hub experience history), demographics, geographic location (e.g., home location, municipality, state, etc.), driving behavior and/or laws associated with the geographic location (e.g., a tendency of local drivers to not stop completely at stop signs and/or at a set of specific intersections, a law allowing right turns during red light intervals at traffic light controlled intersections, etc.), user device application profile (e.g., based on installed applications, application activity, notification activity), user distractibility, or any other suitable user attribute. For example, a high-risk profile or high distraction profile can be assigned to a user profile with a first user device application profile associated with high distraction, such as many installed messaging applications and/or frequent interaction with the user device while driving, and a low-risk profile or low distraction profile is assigned to a user profile with a second user device application profile associated with low distraction, such as usage of an application associated with the on-board vehicle system and/or minimal interaction with the user device while driving. The user profile can be universal (e.g., apply to all users), individual (e.g., per driver), vehicular (e.g., per vehicle, shared across all drivers of the given vehicle), for a population, or be for any suitable set of users. The user attribute values stored by the user profile are preferably generated by applying machine learning techniques (e.g., those disclosed above, alternatively others) to the vehicle data received from the on-board vehicle systems when the user is driving (or within) the vehicle. Alternatively or additionally, the user attribute values can be received from the user (e.g., manually input), from a secondary user, extracted from secondary sources (e.g., from social networking system content feeds generated by or received by the user, from social networking system profiles, etc.), or otherwise determined.

The user profile can include one or more modules (e.g., the algorithms used above; other algorithms, etc.) configured to determine a notification (e.g., based on the imminent driving event), wherein determining the notification S130 can include using the module. In one variation, the module can be an algorithm for determining a notification based on a driving event class and image analysis data. In a specific example of this variation, based on a reversing event class and image analysis data indicating a likely collision with an obstacle depicted in a portion of an image, an algorithm of a first user profile can determine a notification including highlighting the portion of the image, displaying the image with the highlight, and playing a sound, whereas a complementary algorithm of a second user profile associated with a different user would instead determine a notification including adding a subtle outline around the portion of the image and displaying the image with the outline.

Notification preferences can include: notification event thresholds (e.g., the threshold probability of an imminent event, above which the user is notified), notification timing (e.g., when the notification should be presented, relative to predicted occurrence of the imminent driving event), notification types (e.g., audio, video, graphic, haptic, thermal, pressure, etc.), presentation parameters (e.g., volume, size, color, animation, display location, vibration speed, temperature, etc.), notification content (e.g., driving recommendation, vehicle instructions, video, virtual representation of physical world, command, warning, context-aware information presentation, personalized recommendations, reminders, etc.), notification device (e.g., smartphone, hub, smartwatch, tablet, vehicle display, vehicle speaker, etc.), or values (or value ranges) for any other suitable notification parameter. Driving preferences can include: vehicle performance preferences, route preferences, or any other suitable driving preference. Vehicle performance preferences can include: fuel injection timing, pressure, and volume; transmission shift RPM, seat settings, steering wheel settings, pedal settings, or any other suitable vehicle parameter. Route preferences can include: preferred traffic density thresholds, preferred routes, highway preferences, neighborhood preferences, terrain preferences, or any other suitable preference. Vehicle information preferably characterizes the vehicle itself, and can include make, model, year, trim, number of miles, faults (past and/or current), travel survey information (e.g., National Household Travel Survey information), vehicle accessories (e.g., bike racks, hitched trailers, etc.), response parameters (e.g., acceleration rate, braking distance, braking rate, etc.), estimated or actual vehicle dynamics (e.g., weight distribution), and/or include any other suitable set of vehicle information.

A user's driving style can include driving characterizations (e.g., “aggressive,” “cautious”), driving characterizations per context (e.g., driving characterizations for dry conditions, wet conditions, day, night, traffic, etc.), reaction time to events (with and/or without notifications), or any other suitable driving style characterization. The driving style can be determined based on the user's driving history (e.g., determined from the on-board vehicle system data, determined from external sources, such as insurance) or otherwise determined. In one example, the user's reaction time to events can be determined by: identifying an imminent driving event based on the on-board vehicle system data from the instant vehicle at a first time, determining when the user identified the imminent driving event (second time) based on the on-board vehicle system data from the instant vehicle (e.g., when user-controlled, on-board vehicle system data parameter values changed), and determining the response time as the difference between the first and second times. However, any other suitable user parameter can be qualified in the user profile.

When individual user profiles are used, the method can additionally include identifying the user, wherein the user profile associated with the identified user can be used. The user can be uniquely identified by the vehicle (e.g., the vehicle identifier), the user device (e.g., a unique user device identifier, a user account associated with the user device), an occupancy sensor of the vehicle, a weight sensor of the vehicle, a biometric sensor of the vehicle, or be uniquely identified in any suitable manner. In one variation, the user is absolutely identified (e.g., using a unique user identifier). For example, when determining the notification S130 is based on a user profile (e.g., initial user profile, updated user profile), S130 can include receiving (e.g., at the sensor system, such as at the hub) a user identifier from a user device and selecting the user profile from a plurality of user profiles, the user profile associated with the user identifier. In a second variation, a user likelihood is calculated based on the on-board vehicle system data and/or external data (e.g., potential user calendars and/or communications), wherein the user profile used is for the highest probability user. The user likelihood can be refined based on driving patterns during the driving session, notification response parameters (e.g., response times, response type, etc.), or based on any other suitable driving session parameter.

Controlling a vehicle notification system to provide the notification S140, functions to notify the user of the imminent driving event. The vehicle notification system can be controlled in response to prediction of an imminent driving event or at any other suitable time. The notification is provided at a notification time, preferably after the first collection time. The notification time can be within a time window after the first collection time. A time window can be a window ending a predetermined time interval after the first collection time (e.g., 1 sec, 10 sec, 1 min, 1 week, etc.), a dynamically determined time window (e.g., determined based on data such as the first data set, a window ending no later than a predicted event time, etc.), or any other suitable time window. In a specific example, the notification time precedes a predicted event time of the imminent driving event by a time interval greater than a user response time interval (e.g., determined based on a user profile, based on historical data, etc.),

Controlling a vehicle notification system to provide the notification S140 preferably includes sending the notification to the vehicle notification system or to any other suitable on-board vehicle system. For example, S140 can include wirelessly transmitting an instruction from the hub to the vehicle notification system, wherein the instruction includes an instruction to provide the notification.

The notification can be determined and sent by the system predicting the imminent driving event, but can alternatively or additionally be determined and/or sent by the vehicle notification system, hub, remote computing system, or any other suitable processing system. When the notification is sent by a processing system remote from the vehicle, the method can include: sending the notification (and/or instructions) to an on-board vehicle system at a first time, and optionally include receiving confirmation of notification provision from an on-board vehicle system (the same or alternatively a different on-board vehicle system) at a second time after the first time. The notification confirmation can additionally include the notification time.

In a first variation, the notification is generated and sent if the probability of a given imminent driving event has surpassed a threshold (e.g., wherein the imminent driving event is determined probabilistically). The threshold can be learned, selected, or otherwise determined. The threshold is preferably stored in the user profile, but can be otherwise determined. In a second variation, the notification is generated and sent if the vehicle operation and/or external data for an analyzed time period meets a predetermined set of values or scores at least a threshold score (e.g., wherein the imminent driving event is determined parametrically). However, the notification can be generated at any other suitable time.

### 5.2 Generating a User Profile.

Receiving a second data set indicative of vehicle operation S250 functions to receive data indicative of user feedback (e.g., data indicative of a user's response to the notification). The data set can be collected at a second collection time, during a second collection time window, or at any other suitable time. The second data set can additionally be used to identify a second imminent driving event, or be used in any suitable manner. The second data set is preferably received at the processing system, but can alternatively be received at the vehicle notification system, the hub, the remote computing system, or by any other suitable system. The second collection time is preferably after the notification time (e.g., within a time window after the notification time), but can alternatively be after the first collection time but before the notification time, or be any other suitable time. The second collection time (or second collection time window) can be determined in real-time (e.g., by the processing system or on-board vehicle system, based on changes in vehicle operation data), asynchronously (e.g., after the driving session, looking back at a historic record of vehicle operation data), or otherwise determined. The second data set preferably includes values for the same vehicle parameters as the first data set, but can alternatively be different.

The method can additionally include determining that the imminent driving event occurred at an actual event time (e.g., based on the second data set). Determining the actual event time can allow for comparison with a predicted event time, and/or can allow any other suitable use. The actual event time can be the second collection time, a predetermined time duration post the second collection time, or be any other suitable time.

Determining a notification effect of the notification on a behavior of the driver S260 functions to determine whether: the driver heeded the notification, and whether the notification prevented the imminent driving event from occurring (e.g., the efficacy of the notification). Determining the notification effect S260 is preferably based on a data set indicative of the notification and the second data set, and can additionally or alternatively be based on: the first data set; data indicative of vehicle operation collected before the first collection time, between the first and second collection times, and/or after the second collection time; historical data; and/or any other suitable data. A data set indicative of the notification can include: the notification, the notification time, notification parameters and/or parameter values (e.g., a notification appearance parameter value associated with the notification), a notification class, a driving event class, and/or any other suitable data.

Determining the notification effect S260 preferably includes analyzing the second data set, optionally along with any other suitable data, to determine whether the notification changed driver behavior. The second data set and any other suitable data can be analyzed in real-time (e.g., during the driving session, as the second set of data is being received, etc.), asynchronously (e.g., after the driving session, etc.), or at any suitable time. The second data set can be analyzed by the remote computing system, the processing system, the user device, or by any other suitable system. In variations in which the second data set includes image data, the image data can be adjusted to compensate for camera tilt. For example, the sensor module can include an accelerometer, and the image data can be adjusted to compensate for camera tilt relative to a gravity vector determined based on data sampled by the accelerometer (e.g., in response to sensor module attachment to the vehicle, at regular intervals, concurrent with image data capture, etc.) before displaying and/or analyzing the image data (e.g., to predict an imminent driving event).

The method can additionally include receiving a third data set including: the second data set and a data set indicative of the notification. The data can be received at the sensor system, the user device, the vehicle, a remote server system, and/or any other suitable system. For example, the method can include, at a remote computing system, receiving the first and second data sets, the notification, and a notification confirmation including the notification time, and then determining the notification effect S260 based on the received data.

In a first variation of S260, the notification effect on driver behavior is determined parametrically (e.g., deterministically). In a first embodiment, parametric classification of the vehicle operation data includes: determining historic vehicle operation data values preceding a similar or the same driving event for the user (e.g., collected without a notification being provided, collected with a different notification being provided, collected with a notification being provided at a different time relative to the driving event occurrence, etc.), and comparing the second data set to the historic data set. The notification can be deemed to have changed driver behavior when the second data set differs from the historic data beyond a threshold difference. In a second embodiment, parametric classification of the vehicle operation data includes: determining an expected set of vehicle operation data values or patterns consistent with an expected user response to the notification, comparing the second data set to the expected set, and classifying the notification to have changed driver behavior when the two sets substantially match. In a first example, vehicle deceleration after a “slow” notification has been presented (e.g., after the first collection time) can be deemed as an effective notification. In a second example, vehicle acceleration after a “slow” notification has been presented (e.g., after the notification time, after the notification time by more than a reaction time interval, etc.) can be deemed as an ineffective notification. In a third example, when the percentage of an object occupying a sensor module camera's field of view increases beyond a threshold rate and the concurrent vehicle velocity is above a threshold velocity after a “slow” notification has been presented, the notification can be deemed ineffective. However, the notification effect can be otherwise parametrically determined.

In a second variation, the notification effect on driver behavior is determined probabilistically. This variation can include: calculating the probability that the notification influenced driver behavior based on the parameter values of the second data set and the parameter values of historic data sets (e.g., of the user or population). The considered factors, factor weights, equations, or any other suitable variable of the probability calculation can be refined based on machine learning, trained on historic vehicle operation data sets for the user or a population of users. However, the notification effect can be otherwise probabilistically determined.

In a third variation, the notification effect on driver behavior is determined based on the on-board vehicle system sensor output. This variation can include: identifying sensor data indicative of user attention to the notification from the on-board vehicle system data, the identified sensor data associated with a notice time; and analyzing the on-board vehicle system data recorded after the notice time to determine whether the notification influenced driver behavior. For example, a driver wrist rotation (e.g., toward the user) detected by a smartwatch accelerometer at a notice time (e.g., within a predetermined time period after notification presentation on the smartwatch) can be identified as the sensor data indicative of user attention to the notification. The vehicle parameters (e.g., vehicle acceleration, transmission position, etc.) recorded subsequent the notice time (e.g., within a predetermined time period) are analyzed to determine the influence of the notification on the driver behavior.

In a fourth variation, the notification effect on driver behavior is determined based on the occurrence of the imminent driving event. This variation can function to determine whether the driving event occurred because the user ignored the notification or whether the user heeded the notification and took corrective action, but failed to avoid the driving event. In this variation, the second data set is analyzed to identify the occurrence of the driving event at an event time (e.g., probabilistically, parametrically, etc.). For example, a vehicle collision can be identified when the second data set includes sudden vehicle deceleration, yelling, collision sounds, data indicative of airbag deployment, data indicative of sudden vehicle system damage, or other data indicative of a collision. Values from the second data set recorded prior to the event time are then analyzed to determine whether the user behavior (e.g., as determined from changes exhibited the secondary data set) was notification-dependent or notification-independent. For example, the user response can be classified as, or have a high probability of being, responsive to the occurrence of the imminent driving event (notification-independent) when the user response was temporally closer to the occurrence of the imminent driving event (as determined from subsequent vehicle operation data) than to the notification time. However, the second data set can be otherwise analyzed or the notification effect on user behavior otherwise determined. However, imminent event detection and vehicle notification can be otherwise achieved.

Generating a user profile based on the notification effect S270 functions to refine the drive event identification and notification generation processes. The user profile is preferably subsequently used to identify imminent driving events for the driver and/or generate notifications, but can additionally or alternatively be used to identify imminent driving events for other drivers, or be used in any other suitable manner. The user profile is preferably an updated user profile generated based on an initial user profile, but can alternately be a new user profile. The user profile can be generated and/or updated based on: the vehicle operation data sets, notification parameters, user response, end result, analysis, user profiles (e.g., initial, previous, and/or current user profile of the driver; user profiles of other drivers), user device status and/or activity (e.g., apps installed on a user device, messaging app usage while driving, etc.), and/or any other suitable raw or processed data. The user profile can be updated by applying machine learning techniques (e.g., as disclosed above, alternatively others), parametrically updating (e.g., accounting for the newly received parameter value in the parameter average), or updating the user profile in any suitable manner. Examples of user profile parameters that can be adjusted can include: driving event frequency, notification generation frequency, updating a driving profile to show a trend in driving style (e.g., recently tending toward “aggressive driving”), notification thresholds (e.g., based on user driving style, based on the notification time empirically determined to have to highest effect or user response probability, based on a user response profile, etc.), notification parameters, or any other suitable user profile parameter.

In a first variation, generating a user profile S270 includes generating a user response profile based on a predicted event time and an actual event time. In one example of this variation, an updated user profile includes an updated user response profile generated based on: an actual event time substantially equal to a predicted event time (e.g., within 100 ms, 1 s, etc.); a notification time preceding the actual or predicted event time by a second time interval (e.g., 2 s, 10 s, etc.); and data including the second data set, which indicates that, after the notification time, the user took action to avoid the driving event occurrence, but that the action was taken too late to successfully avoid the driving event occurrence. In this example, the updated user response profile can be generated such that it reflects the delay between the notification time and the user's action in response to the notification. In this example, the method can additionally include determining a user response time interval based on the updated user response profile. Based on this determination, future notifications can be provided earlier relative to an associated event time. For example, a second notification associated with a second imminent driving event (e.g., subsequent driving event) can be provided such that the second notification time precedes a predicted second event time by a time interval greater than the user response time interval (e.g., wherein the predicted second event time is predicted based on the updated user profile). Notifications can be provided earlier by reducing an associated threshold (e.g., for predicting an imminent driving event, for determining whether a notification should be provided for an imminent driving event, etc.), and/or in any other suitable manner.

In a second variation, in which an updated user profile includes a module configured to determine a notification based on an imminent driving event, generating the updated user profile can include generating the module based on a supervised learning process based on a notification effect (e.g., the notification effect determined in S260).

The method can additionally include transmitting the user profile. The user profile can be transmitted after generating a user profile S270, or be transmitted at any other suitable time. For example, the method can include transmitting an updated user profile from a remote computing system to the sensor system, in response to generating the updated user profile at the remote computing system.

### 5.2 Generating an Additional Notification.

The method can additionally include generating an additional notification S300, which functions to utilize the updated user profile. Generating an additional notification S300 can include repeating any or all elements of S100 and/or S200, and can additionally include any other suitable elements. The repeated elements of S100 and/or S200 can be performed identically to, in a similar manner as, or differently from their first and/or previous performance. S300 can include elements of S100 and/or S200 not performed during the first and/or previous performance of S100 and/or S200. S300 is preferably performed based on the updated user profile, but can additionally or alternatively be performed based on a previous user profile and/or any other suitable profile, or alternatively based on no user profile.

Generating an additional notification S300 can be repeated multiple times to provide notifications for additional imminent driving events. In variations in which S300 is performed based on the updated user profile, subsequent iterations of S300 can be based on the same updated user profile, based on a different updated user profile (e.g., a user profile further refined through additional iterations of S200), based on any suitable profile, or based on no user profile. In a first example, each iteration of S300 is based on a user profile generated during the previous iteration. In a second example, iterations of S300 performed within a single driving session use the same user profile, while iterations of S300 performed within separate driving sessions use different user profiles. In this second example, S200 can be performed once per driving session, and generating the updated user profile can be performed based on data collected from multiple iterations of S100.

A driving session can be defined by or determined based on engine status, transmission status, vehicle door status, user device status, and/or any other suitable factors, and is preferably a continuous time interval (e.g., a time interval during which the engine remains in an on state, the transmission is not in a park state, the driver door remains closed, the user device remains within the vehicle, the driving event class is unchanged, etc.; a time interval of a predetermined duration, such as 5 min, 1 hr, or 1 day; etc.), but can alternatively be otherwise determined.

One embodiment of the method includes: during a first driving session, providing a first notification S100, including predicting a first imminent driving event, and determining user profile updates S200 to generate an updated user profile; and during a second driving session after the first driving session, generating an additional notification S300 based on the updated user profile. In this embodiment, S300 can include predicting a second imminent driving event for the driver, determining a second notification based on the second imminent driving event and the updated user profile, and controlling the vehicle notification system to provide the second notification at a second notification time. One variation of this embodiment includes classifying both the first and second imminent driving events as belonging to a first driving event class.

In a first example of this variation, in which the first notification effectively alerted the driver to and allowed the driver to avoid the first imminent driving event, the second notification can be similar to (e.g., similar characteristics, same notification type and/or sub-type, comparable intensity, equal notification parameter values, similar notification timing, etc.) the first notification. In a specific example, the driving event class can be a collision with a stationary obstacle, and both the first and second notification can include red highlighting of an image region depicting the obstacle. In a second example of this variation, in which the driver took action to avoid the first imminent driving event before the first notification time, the second notification can be subtler (e.g., lower intensity, different notification type and/or sub-type, later timing, having fewer notification elements, etc.) than the first notification. In a specific example, the driving event class can be cross-traffic at an intersection, the first notification can include generating a loud alarm sound and displaying a large “stop” user instruction superimposed on an image of the cross-traffic, and the second notification can include generating no sound and displaying a small “caution” user instruction superimposed on an image of the cross-traffic. In a third example of this variation, in which the driver did not successfully avoid the first imminent driving event, the first notification can be subtler than the second notification. In a specific example, the driving event class can be parallel parking, providing the first notification can include generating sound at a first characteristic volume, and providing the second notification can include generating sound at a second characteristic volume greater than the first characteristic volume. A characteristic volume can be a peak, near-peak, average, rms, weighted (e.g., A-, B-, C-, D-, or Z-weighted), or perceived volume, or any other suitable volume metric.

Embodiments of the system and/or method include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

We claim:

1. A method for dynamic notification generation for a driver of a vehicle, the method comprising:
during a first driving session:
receiving a first data set from a sensor module attached to the vehicle, the first data set comprising image data, the first data set collected at a first collection time;
predicting a first imminent driving event based on the first data set, the first imminent driving event associated with the vehicle moving backward;
determining a first notification based on the first data set, the first notification associated with the first imminent driving event;
controlling a vehicle notification system within the vehicle to provide the first notification at a first notification time, wherein the first notification time is within a first time window after the first collection time; and
collecting a second data set within a second time window after the first notification time;
determining, based on the second data set, a notification effect of the first notification on a behavior of the driver;
generating an updated user profile based on the notification effect; and
during a second driving session after the first driving session:
predicting a second imminent driving event for the driver;
determining a second notification based on the second imminent driving event and the updated user profile; and
controlling the vehicle notification system to provide the second notification at a second notification time.

2. The method of claim 1, further comprising classifying the first imminent driving event as belonging to a first driving event class and classifying the second imminent driving event as belonging to the first driving event class.

3. The method of claim 2, wherein providing the first notification comprises generating sound at a first characteristic volume and providing the second notification comprises generating sound at a second characteristic volume greater than the first characteristic volume.

4. The method of claim 1, further comprising:
predicting that the first imminent driving event will occur at a predicted first event time;
determining that the first imminent driving event has occurred at an actual first event time, based on the second data set;
generating an updated user response profile based on the predicted first event time and the actual first event time;
determining a user response time interval, based on the updated user response profile; and
predicting the second imminent driving event will occur at a predicted second event time, based on the updated user profile;
wherein:
the second notification time precedes the predicted second event time by a time interval greater than the user response time interval;
generating the updated user profile further comprises generating the updated user response profile; and
the updated user profile comprises the updated user response profile.

5. The method of claim 1, wherein the updated user profile comprises a module configured to determine the second notification based on the second imminent driving event; wherein determining the second notification further comprises using the module.

6. The method of claim 5, wherein generating the updated user profile further comprises generating the module based on a supervised learning process based on the notification effect.

7. The method of claim 1, further comprising receiving a vehicle-originated data set from the vehicle, wherein predicting the first imminent driving event is further based on the vehicle-originated data set.

8. The method of claim 1, wherein:
the first data set is received wirelessly at a hub attached to the vehicle;
the vehicle notification system comprises a user device comprising a display and a speaker; and
controlling the vehicle notification system to provide the first notification further comprises, at the hub, wirelessly transmitting an instruction to the vehicle notification system, the instruction comprising an instruction to provide the first notification.

9. The method of claim 1, wherein:
the first data set comprises an image of a portion of an obstacle;
predicting the first imminent driving event further comprises:
determining an obstacle position of the obstacle relative to the vehicle based on the first data set;
predicting a vehicle path of the vehicle; and
determining a potential collision between the vehicle and the obstacle based on the obstacle position and the vehicle path; and
the first notification comprises the image.

10. A method for dynamic notification generation for a driver of a vehicle, the method comprising:
at a sensor system attached to the vehicle:
collecting a first data set at a first collection time;
receiving a vehicle-originated data set from the vehicle;
predicting, based on the first data set and the vehicle-originated data set, a first imminent driving event;
determining, based on the first data set and the vehicle-originated data set, a first notification associated with the first imminent driving event;
controlling a vehicle notification system within the vehicle to provide the first notification at a notification time, wherein the notification time is within a first time window after the first collection time; and
collecting a second data set within a second time window after the notification time;
at a remote computing system:
receiving a third data set, the third data set comprising: the second data set and a data set indicative of the first notification;
determining, based on the third data set, a notification effect of the first notification on a behavior of the driver;
generating an updated user profile based on the notification effect; and
transmitting the updated user profile to the sensor system; and
at the sensor system:
predicting a second imminent driving event for the driver;
determining a second notification based on the second imminent driving event and the updated user profile; and
controlling the vehicle notification system to provide the second notification.

11. The method of claim 10, wherein:
the sensor system comprises a sensor module and a hub;
collecting the first data set occurs at the sensor module; and
receiving the vehicle-originated data set occurs at the hub;
the method further comprising:
wirelessly transmitting the first data set from the sensor module to the hub before predicting the first imminent driving event.

12. The method of claim 11, wherein:
the first imminent driving event and the second imminent driving event are associated with the vehicle moving backward; and
the first data set further comprises image data.

13. The method of claim 12, wherein the vehicle-originated data set comprises data indicative of the vehicle being in a reverse gear.

14. The method of claim 10, wherein:
determining the first notification is further based on an initial user profile; and
generating the updated user profile is further based on the initial user profile.

15. The method of claim 14, wherein determining the first notification further comprises:
performing classification of the first data set and the vehicle-originated data set to predict a driving event class;
selecting a notification class associated with the driving event class; and
determining the first notification based on the notification class.

16. The method of claim 14, further comprising:
at the sensor system, receiving a user identifier from a user device; and
selecting the initial user profile from a plurality of user profiles, the initial user profile associated with the user identifier.

17. The method of claim 10, wherein receiving the vehicle-originated data set further comprises receiving the vehicle-originated data set through an OBD-II diagnostic connector.

18. The method of claim 10, wherein the data set indicative of the first notification comprises the notification time and a notification appearance parameter value associated with the first notification.

19. The method of claim 10, wherein predicting the first imminent driving event is further based on a second user profile of a second user, the second user within a threshold geographic distance of the vehicle.

20. The method of claim 10, wherein:
the first data set comprises an image;
the method further comprises predicting a region of the image associated with the first imminent driving event, the region smaller than the image; and
the first notification comprises a notification image based on the region of the image.
